(19) United States
(12) Patent Application Publication
(10) Pub. No.: US 2005/0254043 A1
(43) Pub. Date: Nov. 17, 2005

(54) Survey system

(75) Inventor: Minoru Chiba, Ashigarakami-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sokkia Co., Ltd., Atsugi-shi (JP)

(21) Appl. No.: 11/128,181

(22) Filed: May 13, 2005

(30) Foreign Application Priority Data
May 14, 2004 (JP) 2004-145692

(51) Int. Cl. G01C 1/00; G01B 11/26

(52) U.S. Cl. 356/141.1; 356/139.1

(57) ABSTRACT

When light other than guide light is searched by error, the collimation direction of a surveying instrument is changed by emitting a continuous-operation command from the side of a target toward the surveying instrument, and a process for searching proper guide light can be restarted. When a direction detector receives disturbing light differing from guide light in the process of searching the guide light emitted from a guide light transmitter of a target by means of a surveying instrument, a continuous-operation command is emitted from the target toward the surveying instrument. Accordingly, the light receiving direction of the direction detector is changed by driving an instrument body, and a horizontal or vertical rotation is made to a position deviating from a light receiving range obtained when the direction detector receives the disturbing light, and thereafter the process of searching the guide light is restarted.

### FIELD OF THE INVENTION

The present invention relates to a survey system capable of remotely controlling a surveying instrument from the side of a target by a single person.

### BACKGROUND OF THE INVENTION

Conventionally, an operator has been forced by necessity of collimating a target placed on a survey point through manual operations when the position of the survey point or the like is measured by a surveying instrument such as a total station (electronic distance/angle meter). In recent years, a surveying instrument capable of automatically collimating a target by means of an automatic collimator has been proposed in order to lessen the labor of the operator and reduce collimation errors committed by the operator. The surveying instrument provided with the automatic collimator can automatically direct a telescope toward a target by calculating the direction of the target in such a way as to emit collimation light along the optical axis of the telescope of the surveying instrument and so as to receive the collimation light reflected from the target.

However, the conventional surveying instrument is structured to emit a laser beam from the surveying instrument toward the target and detect light reflected from the target during a full rotation of the surveying instrument. In addition, a light receiving range of a light receiving portion that detects reflected light is narrow, and the body of the surveying instrument has been required to be operated in at least the total space while repeatedly performing upward and downward scanning operations.

Therefore, a proposal has been made to provide a surveying instrument capable of immediately detecting a target (collimation target) and collimating the target in a short time without operating the body of the surveying instrument in the total space (see Japanese Published Unexamined Patent Application No. 2000-346645)

In more detail, the proposal has been made as follows. As shown in FIG. 6, guide light 15 is emitted from a light projector 14 placed at a collimation target 3 toward a surveying instrument 2, and, when the guide light 15 is detected by any one of light-receiving-and-detecting portions mounted on four surfaces of the body of the surveying instrument 2, the rotational direction of a telescope is calculated in accordance with a detection result of the light-receiving-and-detecting portion that has received the guide light 15, and the telescope is directed roughly toward the collimation target 3 based on the result of this calculation.

### SUMMARY OF THE INVENTION

In the conventional technique, a one-man survey can be performed through operations carried out by an operator if this operator exists on the side of the collimation target 3. However, since a light receiving range of a light-receiving-and-detecting portion in the conventional survey system is narrower than a searching range (e-g., 360 degrees), a scanning operation performed while rotating the light-receiving-and detecting portion is required. Moreover, when light (e.g., disturbing light) other than the guide light 15 is received in advance on the side of the body of the instrument during this scanning operation and when the disturbing light is erroneously regarded as the guide light 15, the telescope is directed in a direction in which the disturbing light has proceeded and fallen on, and a process for searching the collimation target 3 will be finished there. Even if the operator clearly understands that the body of the instrument has been directed in the direction differing from a direction followed by the guide light 15 as a result of judging from the direction of the light-receiving-and-detecting portion at this time and even if the process for again searching the collimation target 3 is intended to be performed, the body of the instrument regards its direction as the direction of the collimation target 3, and the searching will be finished as long as the direction of the light-receiving-and-detecting portion is set at the incoming direction of the disturbing light. Therefore, even if the process for searching the collimation target 3 is repeatedly performed, the collimation target 3 cannot be properly found.

If the operator exists on the side of the body of the instrument, it is possible that the operator rotates the body of the instrument and the telescope so that the disturbing light does not fall on the light-receiving-and-detecting portion, and thereafter the searching is restarted. However, in the case of the one-man survey in which the operator does not exist on the side of the body of the instrument, troublesome operations must be performed as follows The body thereof and the telescope are commanded to be rotated by remote control from the side of the collimation target 3, and it is ascertained that the disturbing light does not fall on the light-receiving-and-detecting portion, and, after that, a process for searching the collimation target is restarted.

The present invention has been made in consideration of the problem of the conventional technique, and it is an object of the present invention to provide a survey system capable of, when light other than guide light is erroneously searched, to restart a process for searching proper guide light in such a way that the collimating direction of a surveying instrument is changed by issuing a command to continuously perform operations from the side of a target toward the surveying instrument.

In order to achieve the object, a survey system is characterized in that the survey system comprises a target provided with a recursion reflector that reflects incident light in an incident direction of the incident light and a surveying instrument provided with an automatic collimator that causes the recursion reflector to automatically coincide with a collimation axis of a telescope, and the survey system further comprises a guide light transmitter that emits guide light either to the target or to the surveying instrument, and the surveying instrument comprises a direction detector for receiving the guide light and detecting a direction of the guide light transmitter; a collimation preparing means for directing the telescope toward the recursion reflector based on a detection signal of the direction detector before actuating the automatic collimator; and a light-receiving-direction changing means for changing a light receiving direction of the direction detector and reactivating the collimation preparing means in response to a continuous-operation command from the target.

When the direction detector receives light, such as disturbing light or noise light, other than guide light in a process during which guide light emitted from the guide light transmitter is being searched, the light receiving direction of the direction detector is changed, and the collimation preparing means is reactivated by commanding the surveying instrument to continue its operation from the side of the target. Therefore, proper guide light can be searched by restarting the process for searching guide light thereafter. In other words, if the direction detector has erroneously regarded disturbing light or noise light as guide light during the search, the surveying instrument responds to a continuous-operation command emitted from the side of the target so as to change the light receiving direction of the direction detector, and, after that, the process for searching guide light is restarted, in order to disregard the disturbing light or the noise light. Hence, proper guide light can be searched. Additionally, the telescope can be directed roughly toward the recursion reflector before starting the automatic collimator by directing the telescope toward the recursion reflector based on a detection signal of the direction detector when proper guide light is searched.

A survey system is further characterized in that the light-receiving-direction changing means rotates the direction detector in a horizontal direction or in a vertical direction to a position deviating from a light receiving range within which the direction detector receives light other than the direct guide light.

When the light receiving direction of the direction detector is changed, the direction detector is rotated in a horizontal direction or in a vertical direction to a position deviating from a light receiving range within which the direction detector receives light other than the direct guide light, and, after that, a process for searching guide light is restarted. Thereby, proper guide light can be searched.

### BRIEF DESCRIPTION OF THE DRAWINGS

FIG. 1 is a block diagram of a survey system showing one embodiment of the present invention.

FIG. 2 is a block diagram for explaining an internal structure of a surveying instrument and an internal structure of a target.

FIG. 3 is a flowchart for explaining the operation of the system of FIG. 1.

FIG. 4 is a flowchart for explaining the operation of the survey system of FIG. 1.

FIG. 5 is a flowchart for explaining a timer check process of the survey system of FIG. 1.

FIG. 6 is a block diagram of a conventional system.

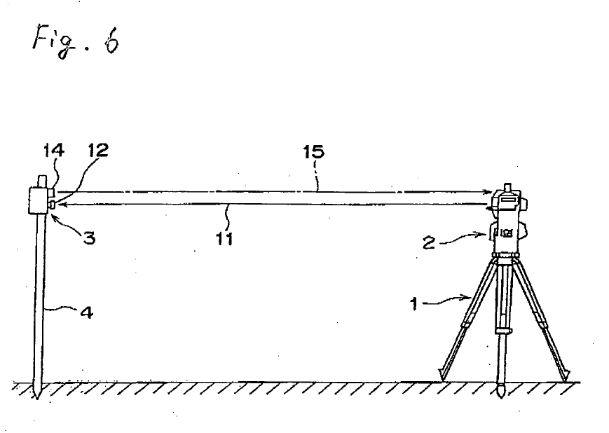

### DETAILED DESCRIPTION OF THE INVENTION

As is apparent from the foregoing description, according to the survey system, it becomes possible to restart the process for searching proper guide light by, from the side of the target, commanding the surveying instrument to continuously perform the operation even when disturbing light or noise light is erroneously regarded as guide light during the search.

It becomes possible to more reliably search proper guide light by rotating the direction detector to a position deviating from a light receiving range within which the direction detector receives light other than guide light.

### BEST MODE FOR CARRYING OUT THE INVENTION

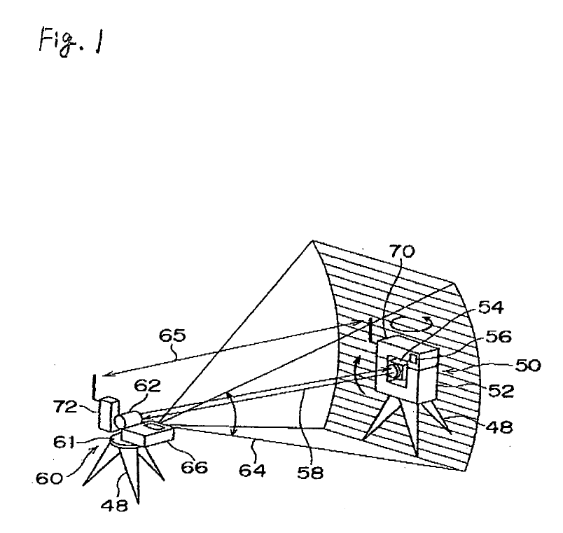

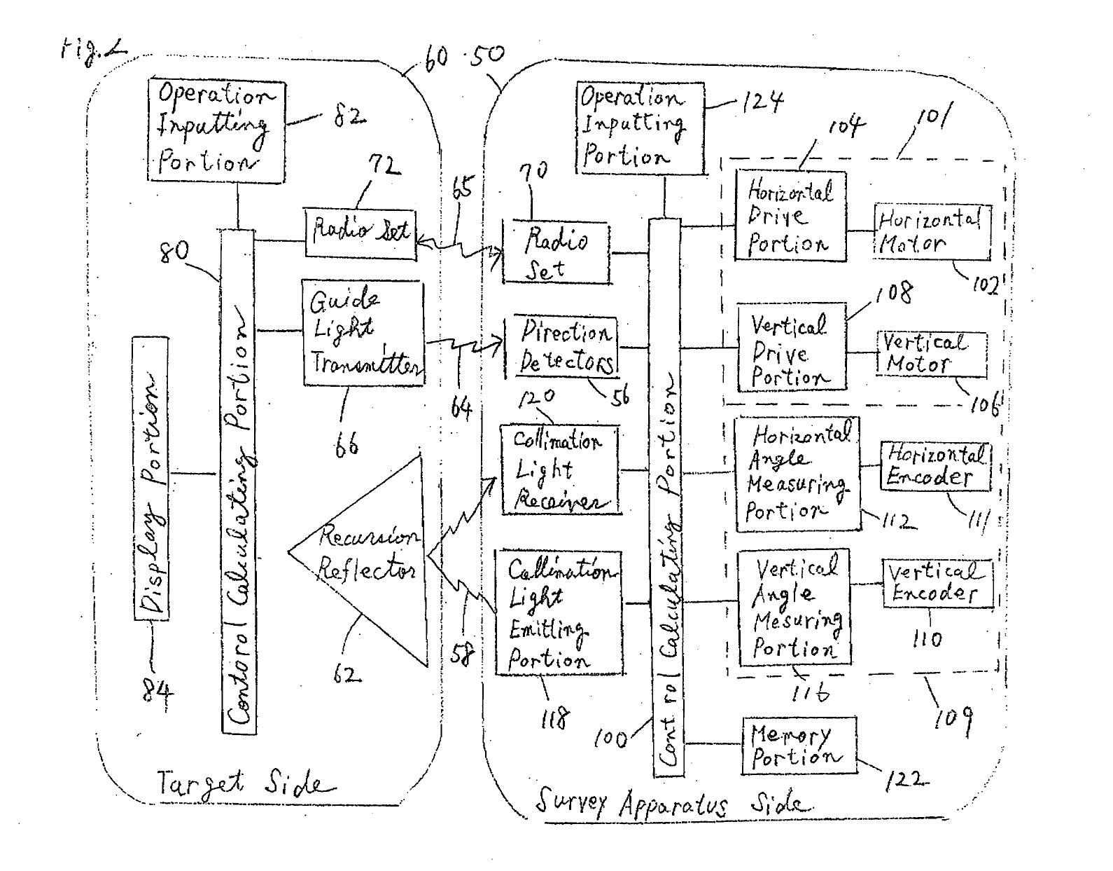

An embodiment of the present invention will be hereinafter described in accordance with the attached drawings. FIG. 1 is a block diagram of a survey system showing one embodiment of the present invention, and FIG. 2 is a block diagram for explaining an internal structure of a surveying instrument and an internal structure of a target.

In these drawings, the survey system of this embodiment consists of a surveying instrument 50 provided with an automatic collimator and a target 60 provided with a recursion reflector 62, such as a reflecting prism, that reflects incident light in its incoming direction as shown in FIG. 1. The surveying instrument 50 is made up of an instrument body 52 placed on a leveling plate (not shown) fixed onto a tripod 48 so that the instrument body 52 can rotate horizontally and a telescope 54 attached to the instrument body 52 so that the telescope 54 can rotate vertically. The target 60 is made up of a recursion reflector 62, placed on a leveling plate 61 fixed onto the tripod 48, that reflects collimation light 58 emitted from the surveying instrument 50 toward the surveying instrument 50 and a guide light transmitter 66, placed on the leveling plate 61, that emits guide light 64, by which the direction of the recursion reflector 62 is made known, toward the surveying instrument 50. The collimation light 58 includes modulation light.

The guide light 64 is a broad fan beam (sector-shaped beam) that is narrow in the vertical direction and that is expansive in the horizontal direction. A scanning operation in the vertical direction is performed with this guide light 64.

The surveying instrument 50 and the target 60 include radios 70 and 72, respectively, by which command signals, survey results, etc., are transmitted via radio waves (electric waves) 65. The main body 52 of the surveying instrument 50 is provided with a direction detector 56 that detects the direction of the guide light 64 of the guide light transmitter 66.

With reference to a block diagram of FIG. 2, a description will now be given of an internal structure of the surveying instrument 50 and an internal structure of the target 60 that are constituent elements of the survey system.

The surveying instrument 50 is made up of a drive portion 101 that directs the telescope 54 toward the recursion reflector 62, a measuring portion 109 that measures a horizontal angle and a vertical angle of sighting point of the telescope 54, a collimation light emitting portion 118 that emits collimation light 58 toward the recursion reflector 62, a collimation light receiver 120 that receives collimation light 58 reflected from the recursion reflector 62, a memory portion 122 that stores data, such as measured angle values, and a central processing unit (CPU) 100 connected to the drive portion 101, to the collimation light emitting portion 118, to the measuring portion 109, to the collimation light receiver 120, and to the memory portion 122. Various commands and data can also be input to the central processing unit 100 from an operating/inputting portion 124.

The drive portion 101 is made up of a horizontal motor 102 that horizontally rotates the instrument body 52, a vertical motor 106 that vertically rotates the telescope 54, a horizontal drive portion 104 and a vertical drive portion 108 that supply a driving current to the motors 102 and 106, respectively. The measuring portion 109 is made up of a horizontal encoder 111 that is horizontally rotated together with the instrument body 52, a vertical encoder 110 that is vertically rotated together with the telescope 54, a horizontal angle measuring portion 112 and a vertical angle measuring portion 116 that read rotation angles of the encoders 111 and 110, respectively, and a distance measuring portion (not shown).

The surveying instrument 50 is provided with an automatic collimator that automatically directs the optical axis (sighting axis) of the telescope 54 toward the recursion reflector 62. The automatic collimator is provided of the central processing unit 100, the collimation light emitting portion 118, the collimation light receiver 120, and the drive portion 101. The automatic collimator operates so that collimation light 58 is emitted from the collimation light emitting portion 118, the collimation light 58, which has been reflected by the recursion reflector 62 and has returned, is then received by the collimation light receiver 120, the direction of the recursion reflector 62 is then judged by the central processing unit 100, and the drive portion 101 is controlled to direct the optical axis of telescope 54 toward the recursion reflector 62.

The surveying instrument 50 of this embodiment is further provided with a collimation preparing means for directing the telescope 54 beforehand roughly toward the recursion reflector 62 before starting the automatic collimator. The collimation preparing means of this embodiment is made up of the radio 70, the drive portion 101, and the central processing unit 100 connected thereto. The collimation preparing means is used to direct the telescope 54 toward the guide light transmitter 66 based on an output signal emitted from the direction detector 56 and to actuate the automatic collimator when it is judged that the telescope 54 has been directed roughly toward the recursion reflector 62.

The surveying instrument 50 of this embodiment is further provided with a light-receiving-direction changing means for changing the light receiving direction of the direction detector 56 and for reactivating the collimation preparing means in response to a continuous-operation command when the radio 70 receives the continuous-operation command emitted from the target 60. The light-receiving-direction changing means is made up of the radio 70, the drive portion 101, and the central processing unit 100 connected thereto. This light-receiving-direction changing means rotates the direction detector 56 in the horizontal or vertical direction to a position deviating from a light receiving range at the present time of the direction detector 56 when the radio 70 receives a continuous-operation command, so that the light receiving direction of the direction detector 56 (i.e., collimation direction of the telescope 54) is changed.

As well as the recursion reflector 62, the guide light transmitter 66, and the radio 72, the target 60 of this embodiment includes a central processing unit 80 connected to the guide light transmitter 66 and to the radio 72. An operating/inputting portion 82 used to input various commands and data and a display portion 84 that displays a state of the target 60 and a state of the surveying instrument 50 are further connected to the central processing unit 80. Each of the radios 70 and 72 has a non-directional antenna so that communications can be transmitted even when the surveying instrument 50 and the target 60 do not exactly face each other. Communications is carried out via radio waves 65.

The target 60 of this embodiment can emit a continuous-operation command from the radio 72 toward the surveying instrument 50 in order to prevent a searching operation for searching disturbing light or noise light when light other than the guide light 64 falls on the direction detector 56, for example, when disturbing light (multi-pass light produced when the guide light 64 is reflected by a reflective object in the field) or noise light (sunlight or reflected light produced when sunlight is reflected by a reflective object in the field) falls on the direction detector 56 in the process of searching the guide light 64 by means of the surveying instrument 50.

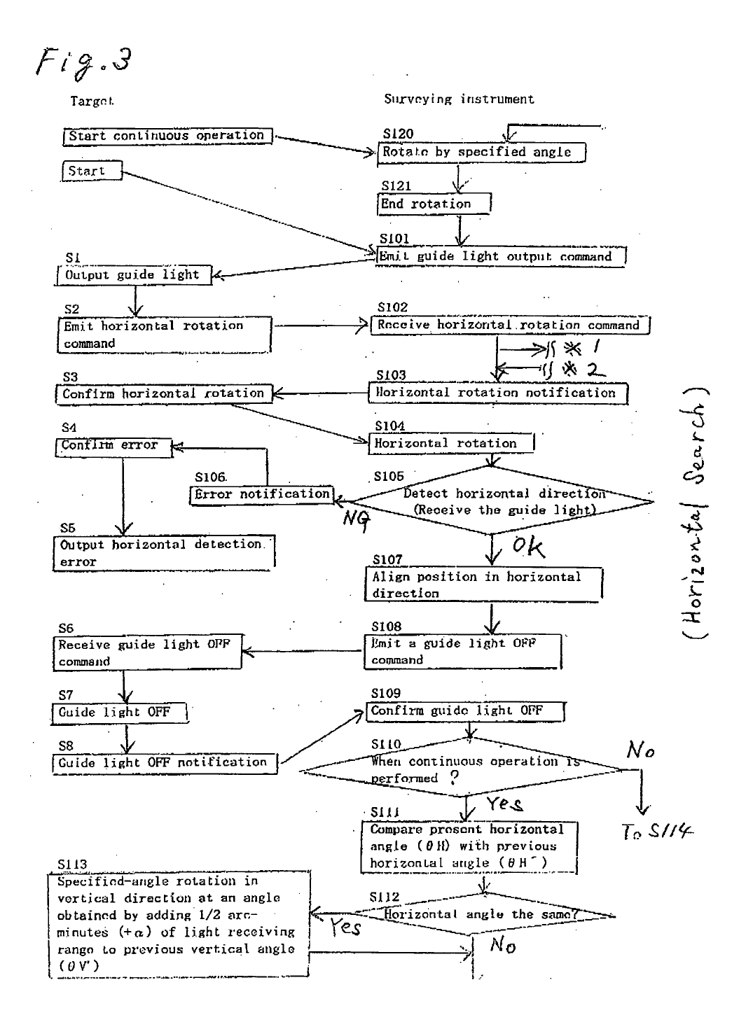

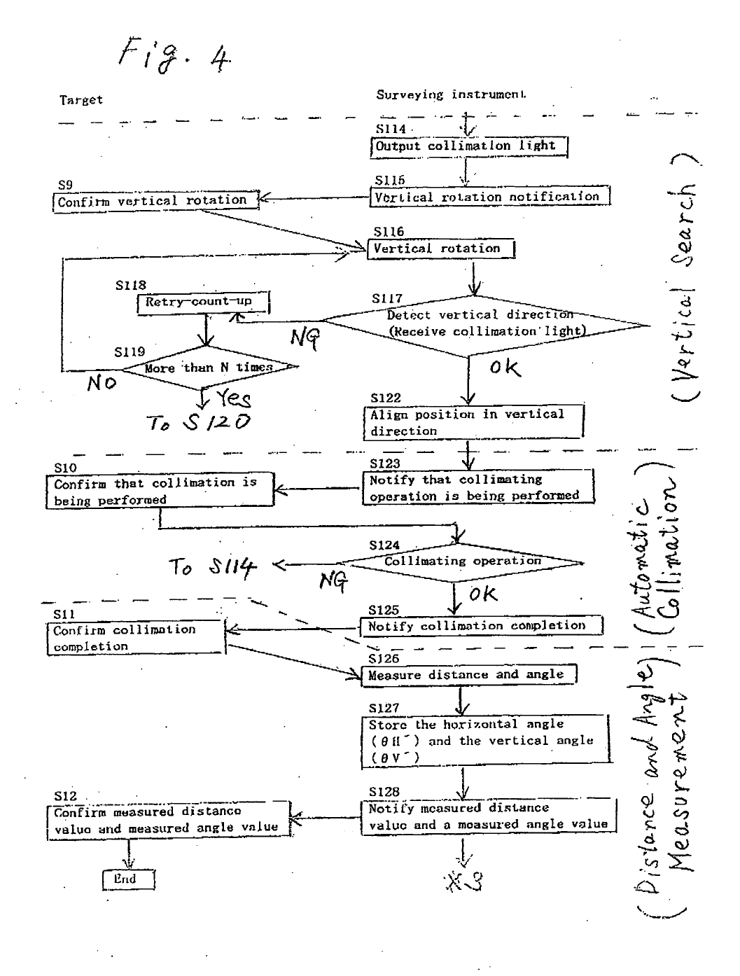

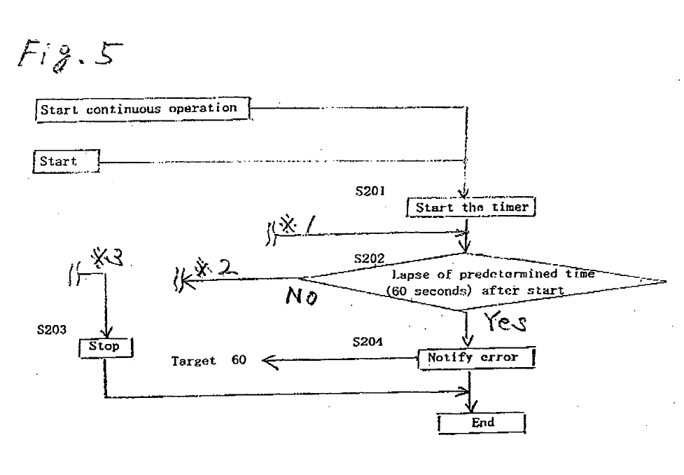

Next, the operation of the survey system of this embodiment will be described with reference to the flowcharts of FIG. 3, FIG. 4, and FIG. 5.

When the survey system of this embodiment is started, a turning process for searching the guide light 64 is started as shown in FIG. 3, and the surveying instrument 50 emits a guide light output command from the radio 70 based on the process of the central processing unit 100 (step S101). When the radio 72 of the target 60 receives the guide light output command, guide light is emitted from the guide light transmitter 66 of the target 60 based on the process of the central processing unit 80 (step S1). Thereafter, a horizontal rotation command is emitted from the radio 72 (step S2). When the radio 70 of the surveying instrument 50 receives the horizontal rotation command (step S102), the radio 70 sends a notification to start a horizontal rotation toward the target 60 (step S103). When it is ascertained that the notification of the horizontal rotation has been received in the target 60 (step S3), it is ascertained on the side of the target 60 that the surveying instrument 50 has started the horizontal search of the guide light transmitter 66. In this embodiment, a timer check process is performed in the central processing unit 100 in parallel with a collimation preparing operation for searching the guide light 64 and an automatic collimating operation. As shown in FIG. 5, if automatic collimation is not finished within a predetermined time after starting the collimation preparing operation (for example, within 60 seconds), that operation is regarded as timed out (step S202), and an error notification (step S204) is performed to the target 60, thereby ending the operation.

On the other hand, the surveying instrument 50 horizontally rotates the instrument body 52 (step S104), and thereafter a determination is made as to whether the guide light 64 can be received or not (step S105). Herein, if the guide light 64 cannot be received even by two rotations of the body 52, an error notification is transmitted to the target 60 (step S106).

When the target 60 receives the error notification, and when it is ascertained that the error notification has been received (step S4), a horizontal detection error is displayed on the screen of the display portion 84 of the target 60, and the operation is stopped (step S5).

On the other hand, when the central processing unit 100 judges that the guide light 64 has been received in step S105, the process proceeds to step S107, where the horizontal rotation of the instrument body 52 is stopped while aligning the horizontal position of the telescope 54 toward the guide light transmitter 66, i.e., while aligning the horizontal position of the telescope 54 in the incoming direction of the guide light 64. Thereafter, the process proceeds to step S108, and a guide light OFF command is emitted from the surveying instrument 50 toward the target 60. When the target 60 receives the guide light OFF command, the target 60 turns the guide light 64 off assuming that the horizontal search of the guide light transmitter 66 has been completed in the surveying instrument 50 (step S7), and a guide light OFF notification is transmitted to the surveying instrument 50 (step S8).

When the radio 70 receives the guide light OFF notification, the surveying instrument 50 ascertains that the emission of the guide light 64 has been stopped on the side of the target 60 (step S109), and thereafter a determination is made as to whether it is time to perform a continuous operation or not (step S110). Herein, if it is judged that it is not time to perform the continuous operation, the process proceeds to step S114. If it is judged that it is time to perform the continuous operation, a comparison is made between the present horizontal angle (θH) and a horizontal angle (θH′) stored by the last process (step S111), and a determination is made as to whether the horizontal angles are the same or not (step S112). Herein, if it is judged that the two horizontal angles are almost the same, an angle equal to ½′(+α) of the light receiving range (e.g., 45′(+α) when the light receiving range of the collimation light receiver 120 is 1°30′) is added to the previous vertical angle θV′ (i.e., vertical angle stored by the last process), and a rotation in the vertical direction is made by the specified angle (step S113). Accordingly, the collimation light receiver 120 moves to a position deviating from the present light receiving range, and the light receiving direction is changed.

On the other hand, when it is judged that the present horizontal angle is not the same as the previous horizontal angle in step S111 or, alternatively, after the process of step S113 is completed, the horizontal search is ended in the same way as when it is judged that it is not time to perform the continuous operation in step S110, and the process proceeds to step S114 shown in FIG. 4 in order to perform a search in the vertical direction.

In step S114, collimation light 58 is emitted from the surveying instrument 50 toward the target 60, and, subsequently, a notification to start rotating the telescope 54 in the vertical direction is sent to the target 60 (step S115). In the target 60 that has received notification of the start of the vertical rotation, it is understood that the surveying instrument 50 has started the vertical search of the recursion reflector 62 by receiving that notification. On the other hand, in the surveying instrument 50, the telescope 54 is rotated in the vertical direction, and the vertical search of the recursion reflector 62 is continued (step S116).

Thereafter, the surveying instrument 50 determines whether the collimation light 58 emitted in step S114 has been reflected by the recursion reflector 62, and the reflected collimation light 58 can be received or not in the process of rotating the telescope 54 in the vertical direction (step S117). Herein, if the collimation light 58 cannot be received, the number of retry-counts is set as plus one in a retry-count-up process (step S118), and, subsequently, a determination is made as to whether the number of retry-counts exceeds N times or not (step S119). Herein, if the number of retry-counts does not exceed N times, the process returns to step S116, where the telescope 54 is again rotated in the vertical direction.

On the other hand, if the number of retry-counts exceeds N times, the process proceeds to step S120 of FIG. 3, where the telescope 54 is rotated by a specified angle in the horizontal direction. This specified-angle rotation process is also performed when a continuous operation is started by emitting a continuous-operation command from the target 60 toward the surveying instrument 50.

When the telescope 54 is horizontally rotated by the specified angle, the direction detector 56 is horizontally rotated to a position deviating from the light receiving range obtained when the direction detector 56 receives light other than guide light, and the light receiving direction of the direction detector 56 is changed.

After the telescope 54 is horizontally rotated by the specified angle, the process returns to step S101, and the same operations are continued from step S101.

On the other hand, if the collimation light 58 is received in step 117 of FIG. 4, the process proceeds to step S122, where the vertical rotation of the telescope 54 is stopped while aligning the telescope 54 with a position in the vertical direction of the recursion reflector 62, and the vertical search is ended.

Thereafter, a shift is made from the vertical search to the process of automatic collimation, a collimating operation is then started, and a notification to the effect that a collimating operation is being performed is transmitted from the surveying instrument 50 to the target 60 (step S123). When the target 60 receives notification to the effect that a collimating operation is being operated, the target 60 ascertains that the automatic collimator has been actuated in the surveying instrument 50 (step S10). On the other hand, at this time, an automatic collimating operation is continued in the surveying instrument 50, and a determination is made as to whether the automatic collimating operation has succeeded or not (step S124). Herein, if the automatic collimating operation has failed, the process returns to step S114, and the same operations are continued. On the other hand, if the automatic collimating operation has succeeded, a notification of collimation completion is sent to the target 60 from the surveying instrument 50 (step S125). When the target 60 receives notification of collimation completion, the target 60 can ascertain that the automatic collimation has been completed in the surveying instrument 50 (step S11). Thereafter, in the surveying instrument 50, a shift is made to distance/angle measuring operations (step S126), and a measured distance value and a measured angle value are obtained. A horizontal angle and a vertical angle obtained by the horizontal search and the vertical search, respectively, are stored in a memory as a horizontal angle (θH′) and a vertical angle (θV′), respectively (step S127), and the measured distance and angle values are transmitted to the target 60 (step S128). When the target 60 receives the measured distance and angle values, survey results, such as the measured distance and angle values, are displayed on the screen of the display portion 84 of the target 60 (step S12), and the survey in this routine is ended. Before ending the survey, the timer is stopped (step S203).

As described above, in this embodiment, when the direction detector 56 receives light other than the guide light 64 while a process for searching the guide light 64 is being performed, the light receiving direction of the direction detector 56 is changed by emitting a continuous-operation command from the target 60 to the surveying instrument 50, and the direction detector 56 is horizontally or vertically rotated to a position deviating from a light receiving range obtained when light other than the guide light is received. Therefore, it is possible to shift to the process for searching the proper guide light 64 while disregarding the light other than the guide light 64 even if the light other than the guide light 64 is erroneously received. Hence, it becomes possible to search the proper guide light 64 and collimate the target 64 in accordance with the search result.

In this embodiment, a description has been given of a case in which the guide light 64 is emitted from the target 60 toward the surveying instrument 50. However, the present invention can be applied to a system in which the guide light 64 is emitted from the surveying instrument 50 toward the target 60 and is received on the side of the surveying instrument 50. In this system, the guide light 64 emitted from the surveying instrument 50 toward the target 60 is reflected by a reflective object in the field, and, when the reflected light falls on the direction detector 56, the reflected light to be searched is disregarded. Therefore, only the proper guide light 64 can be searched without searching the reflected light by emitting a continuous-operation command from the target 60 to the surveying instrument 50.

When this survey system is stopped by error, it is recommended to remove the cause of the error and then restart the survey system.

Since the guide light 64 is a fan beam that is horizontally broad and vertically narrow in this embodiment, the guide light 64 can be caused to reach a distant point with small electric power. Moreover, the guide light 64 is projected in a wide range in all directions while performing a vertical scanning operation therewith. Therefore, the direction detector 56 mounted on the surveying instrument 50 reliably receives the guide light 64 even if the surveying instrument 50 and the recursion reflector 62 do not exactly face each other, and collimation preparations can be performed beforehand to direct the telescope 54 substantially toward the recursion reflector 62 before starting the automatic collimation. The collimation preparations make it possible to shorten the time required for the automatic collimation and therefore shorten the time required for an entire survey.

1. A survey system comprising:
a target provided with a recursion reflector that reflects incident light in a direction in which the incident light has proceeded and fallen on,
a surveying instrument provided with an automatic collimator that causes the recursion reflector to automatically coincide with a collimation axis of a telescope, and
a guide light transmitter that emits guide light either to the target or to the surveying instrument,
the surveying instrument comprising:
a direction detector for receiving the guide light and detecting a direction of the guide light transmitter;
collimation preparing means for directing the telescope toward the recursion reflector based on a detection signal of the direction detector before actuating the automatic collimator; and
light-receiving-direction changing means for changing a light receiving direction of the direction detector and reactivating the collimation preparing means in response to a continuous-operation command from the target.

2. The survey system as recited in claim 1, wherein the light-receiving-direction changing means rotates the direction detector in a horizontal direction or in a vertical direction to a position deviating from a light receiving range within which the direction detector receives light other than the direct guide light.
